(19) United States
(12) Patent Application Publication
(10) Pub. No.: US 2022/0008940 A1
(43) Pub. Date: Jan. 13, 2022

(54) CONSTRUCTIVE ARRANGEMENT PROVIDED IN NOZZLE FOR SPRAYERS

(71) Applicant: TRAVICAR TECNOLOGIA AGRÍCOLA LTDA, Porto Alegre (BR)

(72) Inventor: Felipe André Boris, Porto Alegre (BR)

(21) Appl. No.: 17/340,605

(22) Filed: Jun. 7, 2021

(30) Foreign Application Priority Data
Jul. 9, 2020 (BR) 202020014088-0

(51) Int. Cl. B05B 5/043; B05B 15/68

(52) U.S. Cl. CPC B05B 5/043; B05B 15/68

(57) ABSTRACT

Constructive arrangement provided in nozzles for sprayers to be installed in self-propelled, trailed boom spray equipment or coupled with a linear cover bus and without the aid of wind, capable of being used next to the nozzle holder where the induction ring allows horizontal and vertical adjustment to the nozzles.

### BACKGROUND OF THE INVENTION

The following description for a utility model refers to the constructive arrangement provided in nozzles for sprayers; developed to be installed in self-propelled, trailed boom spray equipment or coupled with a linear roof bus and without the aid of wind, where the induction ring allows simplified vertical and horizontal adjustment to the nozzles.

### DESCRIPTION OF THE STATE OF THE ART

Conventional spraying is similar to electrostatic spraying, with the difference that in the last one the drops are electrically charged, which significantly increases the efficiency of the system. This type of equipment has the capacity of general drops with a high intensity of static electric charge, so that these electrified drops when approaching any object, for example, a leaf, form a large electrostatic field, inducing the appearance of forces of attraction between the drops and the leaf.

As the force of electrical attraction is greater than the force of gravity, the drops are able to deposit on all parts of the plant, even on the underside of the leaves, where a high concentration of pests occurs.

The equipment works by electrifying the spray liquid. For electrification to occur, it is necessary to use an induction electrode that is positioned a few millimeters from the liquid, at the point where it breaks into drops, achieving a very intense electrostatic field with relatively low voltages. However, the biggest problem with this method is that the droplets produced have polarity opposite to the induction electrode and thus they are strongly attracted to deposit on their surface, causing their wetness to the drip point. The presence of liquid on the surface of the induction electrode generates ionization points, which discharge the formed drops or generate electrical sparks, reducing the effectiveness of the nozzle.

Solutions to this problem were described in Brazilian document BR 202014002428-5. However, in this document the nozzle body was smooth and caused cleaning problems. To solve this, Brazilian document BR 202015023211-5 was developed, whose body has extension fins, so that chemicals fall on the nozzle body, being expelled by inclination and gravity.

However, in these documents, there is no possibility for the user to change the nozzle in a simplified way, as nozzle holders with more than one nozzle are used in electrostatic sprayers.

Another drawback concerns the induction ring in a mounting away from the spray nozzle as in the case of Brazilian document BR 102017026883-7. The big problem with this document, which is not suitable for use in nozzle holders, because every time the spray nozzle is changed, it has to move in the extender due to the induction ring not changing its distance from the nozzle tip.

Thus, due to the considerations pertinent to the state of the art previously discussed, it is one of the objectives of the present utility model now proposed; develop an electrostatic spray nozzle that can be used in existing nozzle holders or with the replacement of the entire set, containing more than one spray nozzle in the same nozzle holder. With this, the following improvements were achieved:
Use a nozzle holder containing one or more adjustable product outlets, in this case, the nozzle holder allows for up to five adjustable outlets;
The vertical and horizontal adjustment has been added to the fixed induction ring. The adjustment of the induction ring is necessary to change the outlets, as there are longer spray tips and other short ones, in which they need adjustment at each change. In addition, the adjustment can be carried out by hand, without the need for tools;
Better use of space, because with this arrangement it is possible to install in any sprayer; and
Induction rings with more conductive capacity.

### DESCRIPTION OF THE DRAWINGS

The characterization of the present utility model is made by means of drawings representative of the constructive arrangement provided in spray nozzle holders, in such a way that the product can be fully reproduced by appropriate technique, allowing full characterization of the functionality of the object claimed.

Based on the figures that express the best or preferential form of realizing the product now idealized, the descriptive part of the report is based, through a detailed and consecutive numbering, where it clarifies aspects that may be implied by the adopted representation, so as to clearly determine the protection now sought.

These figures are merely illustrative and may present variations, as long as they do not run away from what was initially claimed.

These are the descriptions of the drawings:

FIG. 1—shows a perspective view of the proposed nozzle, containing five spray nozzles and self-cleaning extension fins;

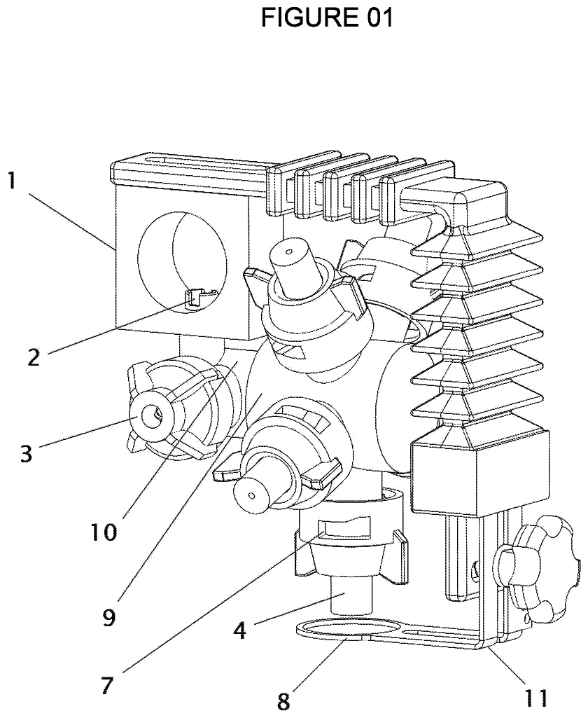

FIG. 2—shows the side view of the spray nozzle;

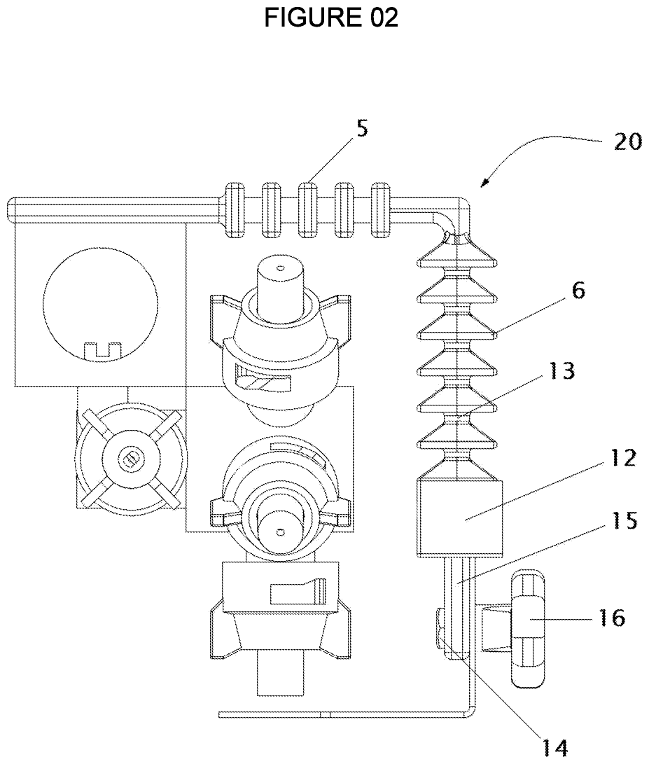

FIG. 3—shows a rear view of the spray nozzle;

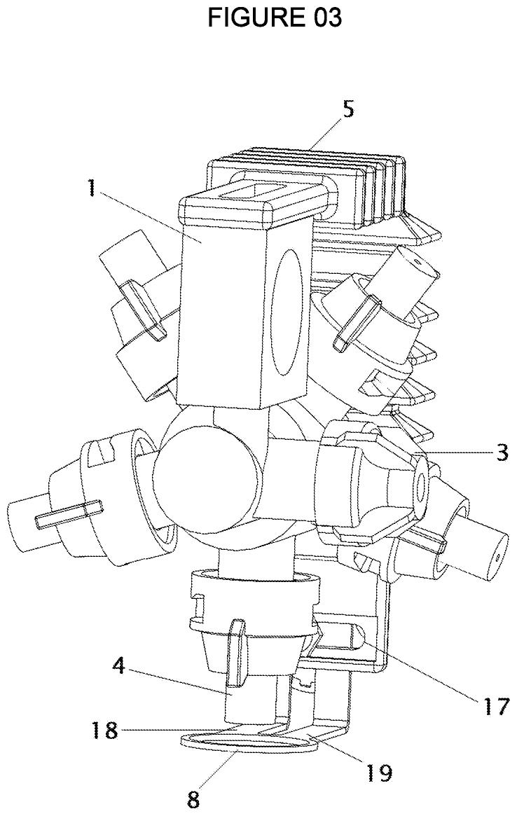

FIG. 4—shows a perspective of a spray nozzle containing four spray nozzles;

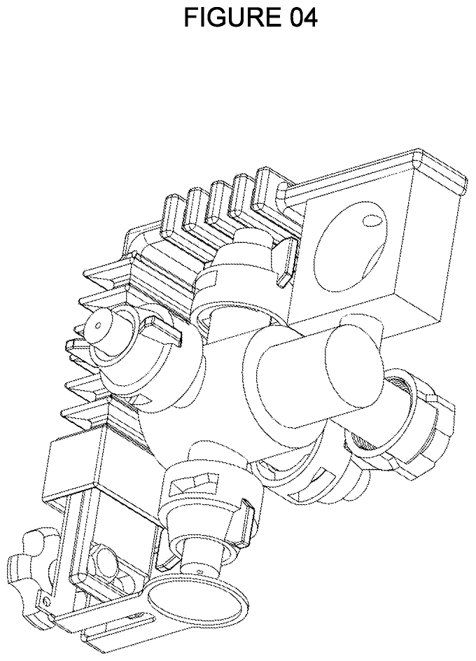

FIG. 5—shows a perspective of a spray nozzle, containing a nozzle holder with three outlets;

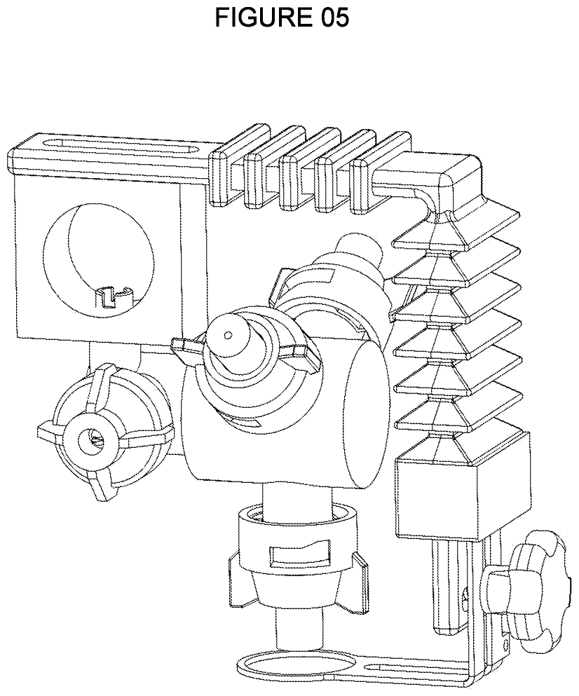

FIG. 6—shows a perspective of a spray nozzle containing a nozzle holder with two outlets;

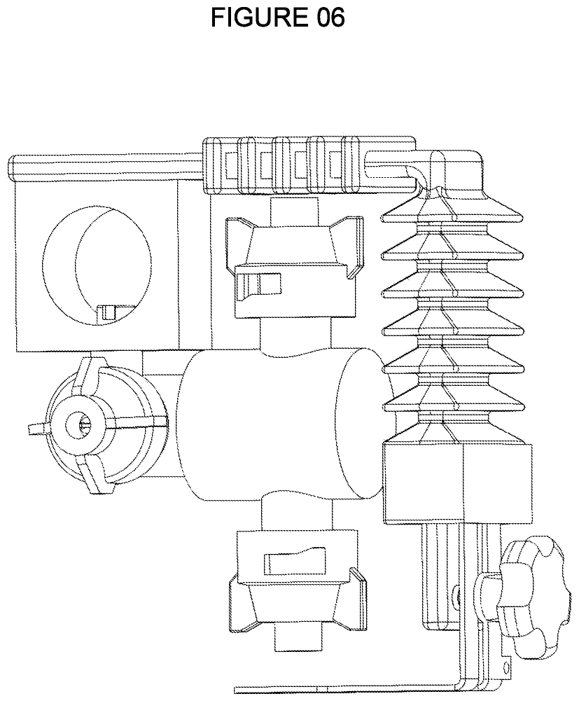

FIG. 7—shows a perspective of a spray nozzle containing an outlet;

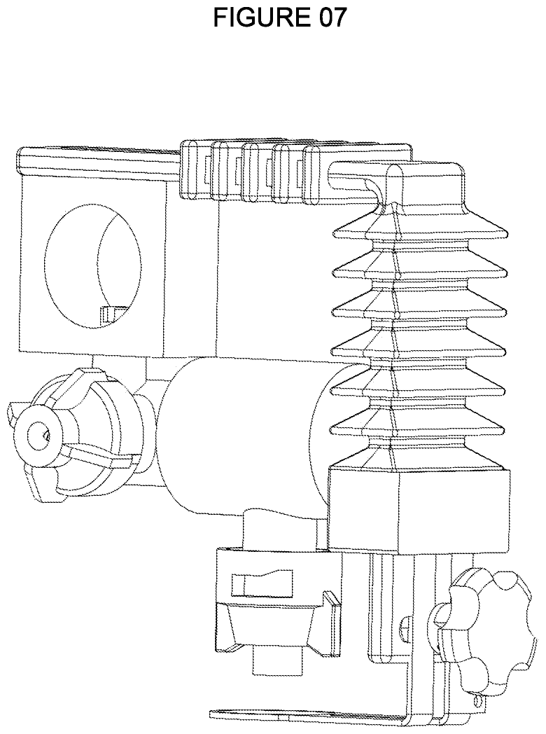

FIG. 8—shows the nozzle with five outlets illustrated in FIG. 01, where a wide and perforated induction ring was used; and

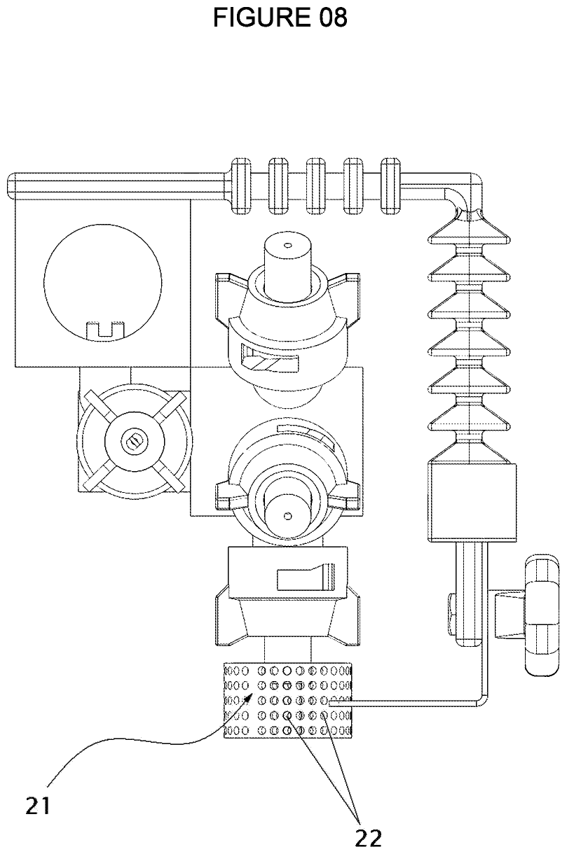

FIG. 9—shows the spray nozzle with five outlets illustrated in FIG. 1, where a wide induction ring without perforations was used.

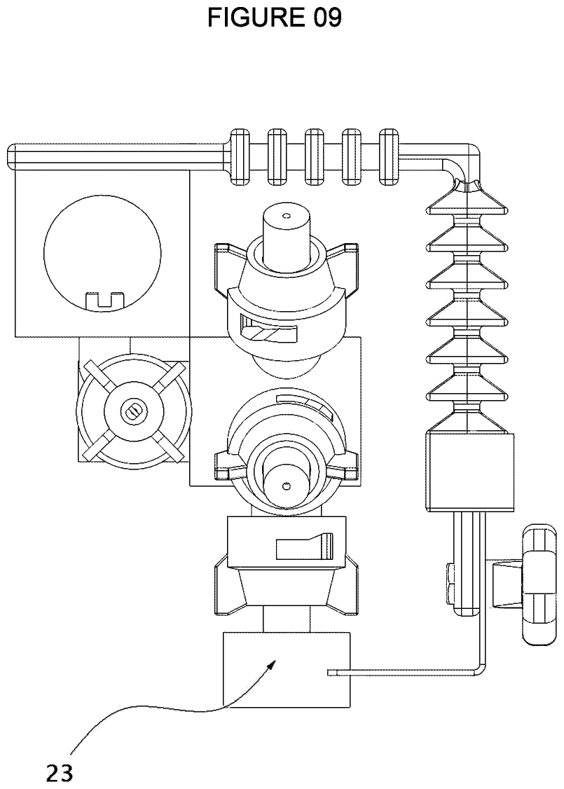

### DETAILED DESCRIPTION OF THE INVENTION

A preferred embodiment of the spray nozzle employs a coupling clamp (1) that is fixed to the spray bar (not shown), where a sealing system (2) is used next to the clamp (1); in order to avoid leakage of the liquid to be sprayed, the liquid to be sprayed passes through the sealing system (2) to the nozzle holder (9) through the duct (10) provided with the anti-drip system (3), where the nozzle holder (9) contains a set of five cone-shaped nozzles with ceramic (4) and manual adjustment (7); and said nozzles are positioned vertically downwards with the ceramic cone tip (4) next to the induction ring (8), where in this arrangement, said induction ring (8) is bent in “L” (11), being attached to the terminal portion (12) of the extender body (13) by means of a screw (14) attached to the support (15); the induction ring (8) admitting upward and downward adjustment and lateral adjustment by means of the knob (16); which acts combined with the oblong hole (17) in the support (15) and due to the induction ring (8) being bent in “L” (11) and composed of two rods (18 and 19).

The extension body (13) is folded in an “L” shape (20), in order to be placed in front of the nozzle holder (9); and to allow the positioning of the induction ring (8) below the nozzles with ceramic cone (4), with said extension body having a plurality of horizontal (5) and vertical (6) fins, with self-cleaning effect.

A proposed spray nozzle construction variant employs a wide induction ring (21), provided with multiple perforations (22). Another construction possibility is to use the wide induction ring (23), but without any perforations.

1. Constructive arrangement provided in nozzle for sprayers comprising using a coupling clamp that is fixed to a spray bar (not shown), where a sealing system is used next to the clamp; the liquid to be sprayed passes through a sealing system to a nozzle holder through a duct provided with the anti-drip system, characterized by:
nozzle holders provided with a set of one or more cone tipped ceramic nozzles;
said nozzles being positioned vertically downwards with the ceramic cone tip next to the induction ring;
said induction ring is bent in “L” , being attached to the terminal portion of the extender body by means of a screw attached to the support, with the induction ring admitting up and down regulation and lateral adjustment by means of the knob; which acts in combination with the oblong hole in the support and due to the induction ring being bent in “L” and composed of two rods; and
said extension body is folded in “L”, in order to be placed in front of the nozzle holder; and to allow the positioning of the induction ring below the nozzles with ceramic cone,
said extension body having a plurality of horizontal and vertical fins.

2. Constructive arrangement provided in nozzle for sprayers, according to claim 1 characterized by presenting spray nozzle construction variants proposed using:
a)—a wide induction ring, equipped with multiple perforations; and
b)—wide induction ring, but without perforations.
